(19) United States
(12) Patent Application Publication
(10) Pub. No.: US 2008/0263672 A1
(43) Pub. Date: Oct. 23, 2008

(54) Protecting sensitive data intended for a remote application

(75) Inventors: Liqun Chen, Bristol (GB); Wael Ibrahim, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company L.P.

(21) Appl. No.: 11/788,082

(22) Filed: Apr. 18, 2007

(51) Int. Cl. H04L 9/32

(52) U.S. Cl. 726/26

(57) ABSTRACT

A method and apparatus is provided of protecting sensitive data input via an input device of a processing platform from a data logger, the sensitive data being user account data intended for a remote application. To protect the sensitive data, the data is used as a password in a secure, password-authenticated key agreement protocol executed between a security entity and the remote application, the security entity being installed in the input device or in secure communication therewith. In one preferred embodiment the input device is a keyboard and the security entity is a unit installed in the keyboard and selectively operable in a pass-through mode and a security mode.

### FIELD OF THE INVENTION

The present invention relates to a method and apparatus for protecting sensitive data input via an input device of a processing platform from a data logger, the sensitive data being account data intended for a remote application. In particular, but not exclusively, the invention relates to a method and apparatus for protecting sensitive account data input via a keyboard from a keylogger.

As used herein, the term “account data” means any data, already known to a third party, that is associated with a user and, either alone or with other data, enables records or other items relating to that user to be distinguished. Examples of account data include, without limitation, bank account number, store account number, network game account details, etc.

### BACKGROUND OF THE INVENTION

A keylogger is a piece of hardware or software installed at a user's machine for capturing the key strokes input by a user through a keyboard or keypad (hereinafter generically referred to as a ‘keyboard’ for simplicity). A software keylogger, once installed to run on a processing platform, such as a PC, traps (stores a copy of) all keystrokes passed to the platform from an associated keyboard. A hardware keylogger is typically interposed between the processing platform and the keyboard to trap and store keystrokes for subsequent reading.

Although there are many valid uses of keyloggers, they are also susceptible to malicious use, for example to capture passwords and other identity information. Unfortunately, it is a relatively easy matter for a dishonest person to surreptitiously install a keylogger; for example, a software keylogger can be installed on a computer simply as a result of a user visiting a web site or opening an email attachment, and a hardware keylogger can be installed in a matter of seconds by, for example, a dishonest employee.

A typical example of the use of a keylogger for identity theft is in connection with online credit card transaction. To make an online payment by using a credit card, a user has to type his credit card details including the user account name, the credit card number and the secure transaction number that is normally the last three numbers printed in the back of a credit card. In many credit card payment products, these messages are protected by an SSL/HTTPS transport session over the Internet, so the information sent is protected between the user's platform and the payment service server, but it is not protected inside of the user's platform. Therefore a keylogger can easily record this information, and later a malicious keylogger owner can impersonate the credit card owner to use the credit card; i.e. one form of identity theft.

One way to defend against some existing keyloggers is to use a virtual keyboard (a keyboard displayed on a screen and operated by a pointing device). However, this approach is ineffective against some new keyloggers that take snapshots of a screen every time a mouse is clicked. To counter this, it is known to use a virtual keyboard in which key selection is effected by hovering the mouse pointer over a key without the need of clicking. However, a sophisticated keylogger may use timing algorithms to take snapshots of the screen in order to see what keys are being selected using the virtual keyboard. In addition to these weaknesses of using a virtual keyboard, there is a usability issue as it is not convenient for a user to use the mouse to type data.

A different approach to protecting against keyloggers is to attempt to detect and remove the keylogger; such an approach is ineffectual against some keyloggers that have proved either undetectable or irremovable.

Other approaches to protecting against keyloggers include encrypting data passing from a keyboard to the operating system (OS) of the processing platform; however, such an approach only protects against a hardware keylogger since once the data arrives at the OS, it is decrypted making it vulnerable to a software keylogger installed on the processing platform.

Another encryption-based approach is disclosed in US 2004/0230805A. This document discloses encrypting data passing between a keyboard and a component (which can be of any type, for example, a program that is executing on a computer, a piece of hardware, etc.). To this end, both the keyboard and the component are pre-installed with a shared secret that is used to set up a secure channel between them. It will be apparent that this approach requires a trustable infrastructure to distribute the keyboard and component and keep track of which keyboard can securely communicate with which component.

### SUMMARY OF THE INVENTION

The invention is set out in the accompanying claims.

### BRIEF DESCRIPTION OF THE DRAWINGS

An embodiment of the invention will now be described, by way of non-limiting example, with reference to the accompanying diagrammatic drawings, in which:

FIG. 1 is a diagram of an embodiment of the invention in which a computer-system keyboard can communicate sensitive data securely to a remote application; and

FIG. 2 is a diagram of a process carried out by the keyboard of FIG. 1 in communicating sensitive data to the remote application.

### BEST MODE OF CARRYING OUT THE INVENTION

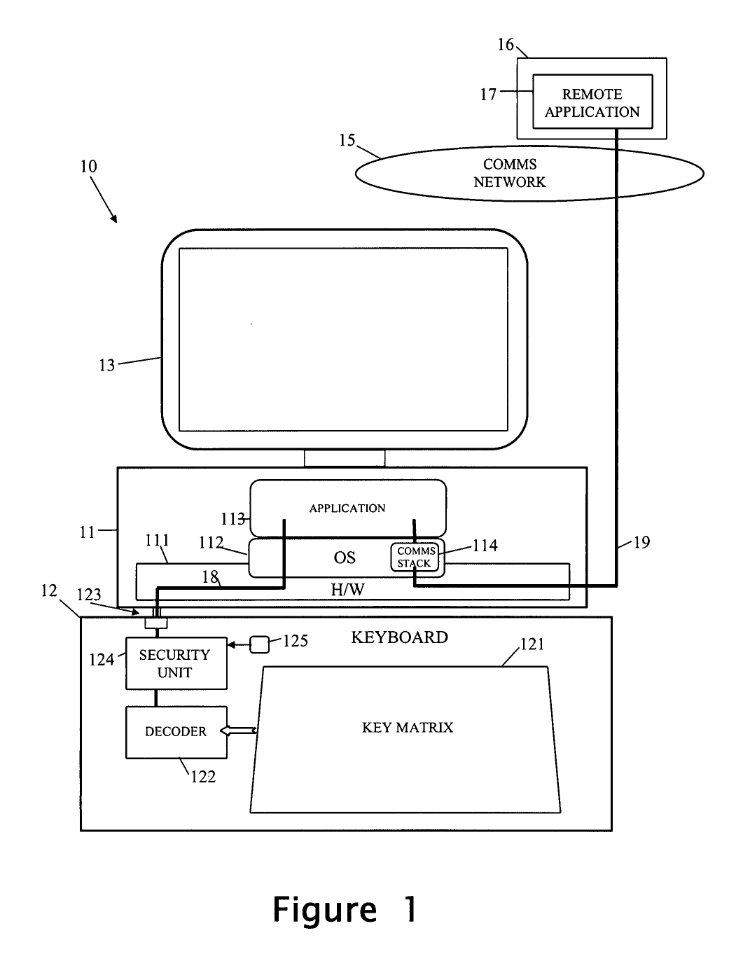

FIG. 1 depicts a processing platform 10 in communication over a communication network 15 (such as the internet) with a remote apparatus 16.

In the present example, the processing platform is a personal computer comprising a processor box 11, an input device in the form of a keyboard 12, and a display 13. The processor box 11 is of conventional form with hardware 111 in the form of a motherboard mounting a processor and its supporting devices such as memory, bus and I/O interfaces, graphics controller etc. In operation, the processor is arranged to load and run an operating system (OS) 112 and one or more applications 113. The OS 112 includes a communication stack enabling the application to set up a communication channel over network 15 with a remote application 17 running on the remote apparatus 16.

The keyboard 12 conventionally comprises a key matrix 121, a key-press decoder 122 and an arrangement 123 (typically, but not limited to, USB based) for interfacing the keyboard 12 with the processor box 11 and permitting data to be passed both to and from the keyboard. The decoder 122 serves to interpret keystrokes and pass corresponding key codes via the interface arrangement 123 to the OS 112 (see path 18) which in turn passes the key codes to the current application 113 (unless the key codes are recognised by the OS 112 as intended solely for itself).

In the present case the keyboard 12 further comprises a security unit 124 interposed between the decoder 122 and the interface arrangement 123. The security unit 124 has two modes of operation, namely a pass-through mode in which it simply passes on, unchanged, (that is, in clear) key codes received from the decoder 122, and a security mode to be described below. A special button 125 (or combination of keystrokes recognised by the decoder 122) is used to toggle the security unit 124 between its two modes of operation. The security unit 124 when in its security mode is arranged to implement a cryptographic protocol (described hereinafter) by means of dedicated hardware or by code run on an internal processor. It is to be understood that use of the term ‘unit’ in relation to the security unit 124 is not intended to imply any particular physical form or arrangement of the hardware/software elements that provide the functionality of this entity.

With the security unit 124 set in its pass-through mode, the computer 10 operates in conventional manner.

Consider a situation where a user is using a browser application 113 to effect an on-line transaction with an enterprise running the remote application 17 and with which the user has an existing account with an associated account number known both to the user and the enterprise; by way of example, the transaction is taken to be a credit card payment to be made using a store card issued by the enterprise.

A user would typically consider their store-card account number to be sensitive data and something not to be disclosed in clear over the internet (the enterprise also has an interest in the account number being kept confidential). Conventionally, therefore, the application 113 causes a secure communication session (for example an SSL session) to be set up between itself and the remote application 17 at least for the passing of the account number from the user computer 10 to the remote application 17.

Once the secure session is established, the application 113 accepts input of the store-card account number from the keyboard 12. With the security unit 124 in its pass-through mode (or absent), the account number typed in by the user is passed in clear over path 18 to the application 113 and is sent on over the secure path 19 to the remote application 17.

Thus, although the account number is protected in passage across the network 15, any keylogger software running on the platform 10 can log the key codes for the account number, as could a hardware keylogger installed between the keyboard 12 and the processor box 11.

According to the preferred embodiment of the present invention, the account number typed in by the user is not passed in clear outside of the keyboard 12 but is used as the password in a secure password-based (also called ‘password-authenticated’) key exchange protocol (also called ‘key agreement’ protocol) set up between the keyboard security unit 124 (operating in its security mode) and the remote application 17. A password-authenticated key agreement protocol is a protocol where two or more parties, based only on their knowledge of a password, establish a cryptographic key using an exchange of messages, such that one who controls the communication channel but does not possess the password cannot participate and is constrained as much as possible from guessing the password. Password-based key agreement protocols are well known per se and are the subject of IEEE P1363.2 and ISO/IEC 11770-4. A specific example is described in Victor Boyko, Philip MacKenzie, and Sarvar Patel, “Provably Secure Password-Authenticated Key Exchange Using Diffie-Hellman”, in Advances in Cryptology—Eurocrypt 2000, Lecture Notes in Computer Science 1807, Spinger-Verlag, 2000. A password-based protocol can be described as “secure” where the password (typically 8-10 characters in length) is not sent in clear or disguised using a simple function (assumed known) and therefore susceptible to a dictionary attack; instead, cryptographic functions are employed that guarantee a very large search space, typically of the order of 2⁸⁰ permutations.

The participation of the remote application 17 in a password-based key agreement protocol set up between the security unit 124 and the remote application 17 requires the latter to have a knowledge of the user's account number (the password), this knowledge being obtained from pre-existing stored data, such as a customer database, associated with the remote application. Preferably, the stored data is accessed to retrieve the account number on the basis of a non-sensitive account identifier (such as a user name) input by the user via the keyboard and transmitted from the keyboard 12 in clear to the local application 113 from where it is sent to the remote application 17.

A comparison operation performed by the remote application 17 based on the key generated by the password-based key agreement protocol serves to confirm to the remote application that it is using the same account number as the security unit 124.

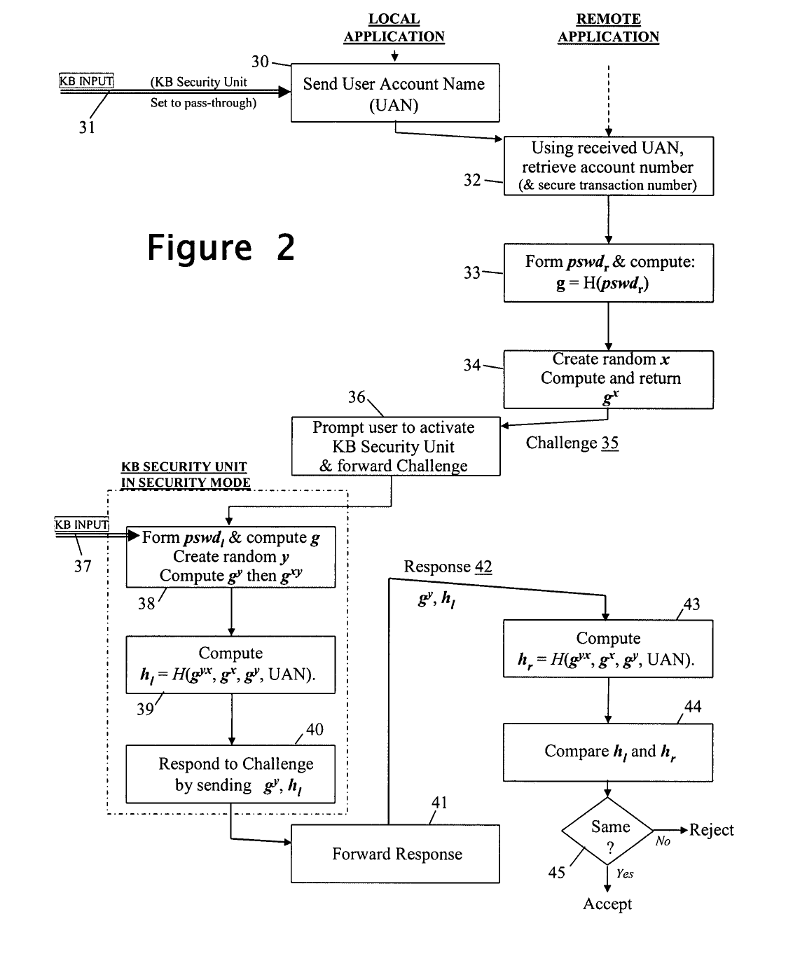

A specific example will now be given, with reference to FIG. 2. It will be assumed that communication between the local application 113 and remote application 17 has been established (this can be within an SSL session or in clear) and the security unit 124 is still in its pass-through mode.

In response to a request from the remote application 17, the user types in at the keyboard 12 an identifier of the user's account (for example, a user account name, UAN)—see arrow 31 in FIG. 2. If the user has more than one account with the enterprise concerned, the user also includes an indicator of which account is to be used. As the security unit 124 is in its pass-through mode the account identifier UAN is passed in clear from the keyboard 12 to the local application 113 from where it is sent to the remote application (see box 30 in FIG. 2). Upon receiving the account identifier UAN, the remote application 17 uses it to retrieve the user's account number and, if required, a secure transaction number (see box 32).

The remote application next forms a password string pswdᵣ either as the account number or the account number and secure transaction number in combination; the suffix r of the password string pswdᵣ indicates that this is the password string formed by the remote application, and then computes:

g=H(pswdᵣ)

where H is a function which converts the value pswdᵣ to a finite field group generator, g, via a secure hash-function. An example of such a finite field group is G with a prime order q where q is a large prime number satisfying q|p−1 and p is another large prime number. Group elements are a set of the values, g^{w} mod p where w is any integer from {0, 1, . . . , q−1}. The process of creating the group generator g from the value pswdᵣ includes the following steps:
Compute h=hash(pswdᵣ), where hash is a secure hash-function, such as SHA-256 (see box 33).
Compute g=h_{(p-1/q)} mod p.

The remote application 17 next creates a random number ‘x’ and computes

g^{x}

where the g^{x} computation is in a finite field group (see box 34), that means the real computation is g^{x} mod p. For simplicity, hereinafter we omit “modp” in the specification. In this group, the problem of computing either the value g or the value x from g^{x} is computationally infeasible.

The remote application 17 sends gₓ to the local application 113 as a challenge 35.

In response to receipt of the challenge 35, the local application 113 prompts the user to activate the keyboard security unit 124 putting it in its security mode. The press or presses that cause the security unit to change into its security mode also result in the local application being informed that this has happened whereupon the local application 113 forwards the challenge 35 to the security unit 124 (see box 36). It does not matter that a key logger can read the challenge as it is passed to the keyboard 12.

On receipt of the challenge, the security unit 124, in its security mode, forms a password string pswdᵣ (where the suffix l stands for ‘local’) based on a user account number and, if needed, secure transaction number, typed in by the user input 37 at the keyboard 12 (input 37); the password pswdₗ has the same form as pswdᵣ and should be the same if all is well. The user input 37 is not passed to the processor box 11 and so cannot be read by a key logger. As depicted in box 38, the security unit 124 then computes:

g=H(pswdₗ)

generates a random number ‘y’, and computes:

g_{y}

in the same finite field group as gₓ followed by computation of:

g^{xy}

Next, the security unit 124 computes:

hₗ=H(g^{yx},gₓ,UAN)

where hₗ is the local copy of the shared key h under creation by the key agreement protocol as is indicated by the suffix l (box 39).

The security unit 124 now responds to the challenge 35 by passing the quantities g_{y} and hₗ to the local application 113 (box 40) which forwards them (box 41) to the remote application 17 as the challenge response 42.

The remote application 17 uses the received value g_{y} to compute g_{yx} to compute its own version hᵣ of key h where the suffix r indicates the remote version of h (see box 43).

The remote application 17 now verifies that is using the correct account number (and secure transaction number where employed) by comparing its computed key value hᵣ with the value hₗ included in the challenge response 42. If there is a match, then the remote application knows it has the correct account number and proceeds with the transaction, otherwise the transaction is terminated (see box 45).

Any data logged by a keylogger in the course of the above protocol is meaningless.

If additional user input is to be passed securely to the remote application, then this can be done by arranging for the security unit 124 to encrypt key codes using a key generated on the basis of the executed key agreement protocol. One way of doing this is to use the value h (=hₗ=hᵣ) as a symmetric key. Of course, in this case the value hₗ must not be included in the response 42 and the check carried out in steps 44 and 45 must be based indirectly on hₗ rather than directly on this value—for example, hₗ could be used by the security unit to encrypt the password pswdᵣ with the encrypted password then being included in the response 42, in place of h₁, for comparison with a corresponding encrypted password computed by the remote application 17.

An alternative would be for both the security unit 124 and the remote application 17 to create a further key h_{f} formed, for example, as:

h_{f}=H((g^{yx},g^{x},g^{y},UAN)∥0)

where ∥ represents concatenation.

As all data sent by the remote application 17 is received by the local application, it is up to the latter to determine when that data is to be passed on to the security unit or acted on by the local application itself. It therefore remains possible for prompts initiated by the remote application to be displayed on display unit 13; thus, when all required sensitive data has been received by the remote application, this can be indicated back to the local application which can prompt the user to change the mode of the security unit 124 back to its pass through mode.

It will be appreciated that the above described embodiment protects sensitive data input at keyboard 12 from local hardware and software key loggers. Furthermore, this protection is achieved without the need to share a special cryptographic secret between the keyboard and the remote application.

Many variants are possible to the above described embodiment of the invention. For example, a different password-authenticated key agreement protocol can be used.

In addition, rather than providing the security unit 124 in the keyboard 12, the security unit could be provided in the processor box 11 (or between the key board 12 and the processor box 11) and arranged to receive the key codes from the keyboard in a secure manner, that is without the key codes being readable by a hardware or software key logger (at least during the security mode of operation of the security unit). One way of achieving this would be to connect the keyboard interface of the processor box 11 directly to the security unit 124 and encrypt all transmissions from the keyboard 12 to the security unit 124 using symmetric or asymmetric encryption. In fact, encrypted transmission of the key codes need only be effected for the operations for which the security unit is set in its security mode, the keyboard 12 at other times sending key codes in clear. It will be appreciated that where the security unit 124 is located in the keyboard 12 itself as in FIG. 1, this alone provides a measure of security regarding the passing of sensitive typed-in data to the security unit 124; additional security can be achieved by making the keyboard housing tamper resistant.

Furthermore, in appropriate circumstances it is possible to dispense with the use of the user account identifier UAN; for example, where the number of accounts is small, the remote application could test the key hₗ received in the challenge response against all possible values of hᵣ derived using the number of each account known to the remote application.

Although in the above example the sensitive account data used for the password was the account number, any other type of account data can be used provided it is appropriately confidential.

The security unit can be used in relation to any input device that outputs user input data capable of being captured by a data logger. Thus, the key matrix and decoder 121, 122 could be replace by an alternative user-input conversion arrangement such as a microphone and speech-to-text converter.

Furthermore, the processing platform with which the input device is associated is not limited to being a personal computer as depicted in FIG. 1 but could be any processing platform such as a PDA or mobile phone.

The input device could be integrated into the same item of equipment as the processing platform.

Furthermore, the communication between the user platform and the remote application can go through other application platforms. For example, a user pays some money for an e-ticket to an e-ticket service provider by using his credit card. The credit card sensitive information was shared between the user and his bank, but not the e-ticket service provider. The authenticated key exchange protocol introduced above is run between the security unit in the user platform and the bank, but the communications of the protocol go through the web site of the service provider. In that case, a trivial modification resulting in making the service provider be passive is required, with which the service provider only learns the user account name UAN and the transcripts of the protocol between the user and the bank, but not any sensitive information.

1. A method of protecting sensitive data input via an input device of a processing platform from a data logger, the sensitive data being user account data intended for a remote application, the method comprising using the sensitive data as a password in a secure, password-authenticated key agreement protocol executed between a security entity and the remote application, the security entity being installed in the input device or in secure communication therewith.

2. A method according to claim 1, comprising:
inputting an account identifier using the input device and sending this identifier in clear from the input device to a local application running on the processing platform;
forwarding the account identifier from the local application to the remote application where it is used to access corresponding account data, this account data then being used by the remote application to initiate said password-authenticated key agreement protocol by generating and returning a challenge to the processing platform for the security entity;
inputting the sensitive user account data using the input device and passing this data securely to the security entity for use in generating a response to said challenge; and
returning said response to the remote application where it is checked to determine whether the user account data used by the remote application in generating the challenge corresponds to the user account data used by the security in generating said response.

3. A method according to claim 2, wherein the security entity is located in said input device, the security entity being normally set in a pass-through mode in which it passes on user input entered at the input device in clear to the local application, the method further comprising setting the security entity into a security mode in which it participates in said password-authenticated key agreement protocol, the security entity when in its security mode inhibiting user input entered at the input device from passing to the processing platform in clear.

4. A method according to claim 3, wherein the security entity is set into its security mode by user input made using said input device.

5. A method according to claim 2, wherein the security entity is located in said processing platform, the input device passing the sensitive user account data input at the device to the security entity over an encrypted link.

6. A method according to claim 2, wherein following the return of a correct response to the remote application, further sensitive data is passed from the input device to the remote application, this further sensitive data being encrypted by the security entity using a key agreed with the remote application as a result of said password-authenticated key agreement protocol.

7. A method according to claim 1, wherein said user account data is an account number.

8. A method according to claim 1, wherein said input device comprises a plurality of user-operable keys.

9. An input device for receiving user input and passing corresponding user data to a processing platform, the device comprising:
a user-input conversion arrangement responsive to user input to produce clear-form user data;
an input/output interface for the exchange of data with the processing platform; and
a security unit selectively operable in:
a first mode in which the clear-form user data produced by the user-input conversion arrangement is passed to the input/output interface, and
a second mode in which the security unit is arranged to execute a password-authenticated key agreement protocol with a remote application and user data produced by the user-input conversion arrangement is inhibited from passage to the input/output interface, this user data being instead used as a password in said protocol.

10. An input device according to claim 11, wherein the input device is a keyboard and the user-input conversion arrangement comprises a key matrix and associated decoder.

11. An input device according to claim 11, wherein the mode of the security unit is arranged to be changed as a result of user input to said user-input conversion arrangement.
